(19) United States
(12) Patent Application Publication
(10) Pub. No.: US 2013/0267203 A1
(43) Pub. Date: Oct. 10, 2013

(54) SENDING PLMN ID AT A SHARED WIFI ACCESS

(71) Applicant: Zu QIANG, Kirkland (CA)

(72) Inventor: Zu QIANG, Kirkland (CA)

(21) Appl. No.: 13/857,458

(22) Filed: Apr. 5, 2013

Related U.S. Application Data
(60) Provisional application No. 61/620,703, filed on Apr. 5, 2012.

(51) Int. Cl. H04W 36/14

(52) U.S. Cl. CPC H04W 36/14
USPC 455/411; 455/437

(57) ABSTRACT

A UE makes use of an indication of the PLMN ID that it selected in communications with a WiFi access network to ensure that the proper connection to a Evolved Packet core is provided.

### REFERENCE TO RELATED APPLICATIONS

This application claims the benefit of priority to U.S. Provisional Patent Application No. 61/620,703 filed Apr. 5, 2012, the contents of which are expressly incorporated herein by reference.

### TECHNICAL FIELD

This disclosure relates generally to mechanisms to ensure proper connection of as 3GPP based UE to a BBF based Wi-Fi network.

### BACKGROUND

The Third Generation Partnership Project (3GPP) and Broadband Forum (BBF) are standardization organizations for mobile and fixed networks respectively. There is an ongoing joint work item on Fixed Mobile Convergence (FMC) between these two organizations as can be seen in the development of 3GPP TR 23.839 and BBF WT 203 standards.

A 3GPP terminal, also referred to as User Equipment or UE, can attach to a BBF access network and get connected to one or more packet data networks (PDNs) via the S2 interface as defined in 3GPP TS 23.402. Each PDN connection is anchored in a 3GPP Packet Gateway (PGW). The UE receives one IP address for each PDN connection. It is the PGW that assigns the IP address.

The S2 interface comes in three flavors; S2a, S2b and S2c. The latter two overlay the BBF network and do not impact BBF. S2a is a more converged solution that does impact BBF nodes.

In S2a, there is a GPRS Tunneling Protocol (GTP) or Proxy Mobile Internet Protocol (PMIP) tunnel for each PDN connection between the BBF Border Network Gateway (BNG) and the 3GPP PGW(s). Between the UE and BNG, a point-to-point link is required in order to separate the traffic from the different PDN connections. Such point-to-point link can be implemented in several ways.

In the following discussion, an assumption is made that the network between UE and BNG is Ethernet-based. All nodes between the UE and BNG do forced-forwarding towards the BNG on Layer 2 (L2) (Ethernet). The BNG always sends downstream traffic targeted for the UE as unicast on L2, even if that traffic is multicast/broadcast on Layer 3 (L3) (IP).

In 3GPP Release 11, only an S2a solution making use of an unmodified UE is provided. With the S2a unmodified UE solution, the UE discovers WiFi coverage and performs 3GPP based access authentication. Once the access authentication is accepted, the S2a tunnel establishment is triggered by using either GTP or PMIP signaling. At the successful establishment of an S2a tunnel, the allocated IPv4 address or IPv6 prefix is sent to the UE using either a DHCPv4 message or Router Advisement message.

The UE Public Land Mobility Network (PLMN) discovery is typically performed using IEEE 802.11u-2011 signaling as specified in 3GPP TS 24.234. The 802.11u signaling can inform the UE which PLMN identifier (PLMN ID) is associated with the Service Set Identifier (SSID) which has been broadcast by an Access Point (AP). The UE can then perform a PLMN selection procedure and initiate the WiFi attachment procedure with the WiFi access point (AP) which is associated with the selected PLMN.

There is a problem when the WiFi AP is shared by more than one operator. If the WiFi access point is shared by more than one operator, the UE may receive a list of PLMN IDs during 802.11u signaling. In the roaming case, the UE may select one PLMN from the list and start the initial attachment procedure. However there is no way for the network to know which PLMN has been selected by the UE. Then the WiFi access network may randomly select a PLMN ID in order to complete the authentication and tunnel setup procedure. If there is a miss-matching between the UE selected PLMN ID and the WiFi access network selected PLMN ID, it may result in incorrect charging.

Therefore, it would be desirable to provide a system and method that obviate or mitigate the above described problems.

### SUMMARY

It is an object of the present invention to obviate or mitigate at least one disadvantage of the prior art.

In embodiments of the present invention, the UE is able to provide an indication to the WiFi access network of the PLMN ID that has been selected by the UE. This indication can be used to reduce the likelihood of incorrect charging due to a mismatch between the selected PLMNs.

In a first aspect of the present invention, there is provided a method of facilitating access to a 3GPP core network associated with a User Equipment (UE) through a non-3GPP network, for execution by the UE. The method comprises the steps of receiving, from an access point in the non-3GPP network, an indication that a plurality of 3GPP core networks can be accessed through the non-3GPP network; selecting, from the indicated plurality, the 3GPP core network associated with the UE; and transmitting, to the access point, an identifier associated with the selected 3GPP core network.

In an embodiment of the first aspect of the present invention, the step of receiving is preceded by a step of establishing a connection to the access point. In a further embodiment, the indication is received in an Extensible Authentication Protocol (EAP) request message, and optionally the identifier is transmitted in an EAP response message. In a further embodiment, the indication includes a list of Public Land Mobility Network identifiers (PLMN ID), each PLMN ID in the list associated with one of the plurality of 3GPP core networks. In another embodiment, identifier is a Public Land Mobility Network identifier.

In a second aspect of the present invention, there is provided a User Equipment (UE) for accessing a 3GPP core network associated with the UE through a non-3GPP core network. The UE comprises a network interface, a processor and a memory. The network interface allows for communication with an access point in the non-3GPP network. The memory stores instructions. The processor executes the instructions stored in the memory and upon doing so is able to identify a message received from the access point through the network interface as an indication that a plurality of 3GPP core networks can be accessed through the non-3GPP network, select the 3GPP core network associated with the UE from the plurality of 3GPP core networks, and transmit to the access point through the network interface an identifier associated with the selected 3GPP core network.

In an embodiment of the second aspect of the present invention, the identified message is an Extensible Authentication Protocol (EAP) request message. In a further embodiment, the stored instructions also cause the processor to transmit the identifier as part of an EAP response message. In another embodiment, the indication includes a list of Public Land Mobility network Identifiers, each identifier in the list associated with one of the plurality of 3GPP core networks.

In a third aspect of the present invention, there is provided a method of facilitating access to one of a plurality of 3GPP core networks by a User Equipment (UE). The method can be executed by a node in a non-3GPP network. The method comprises the steps of receiving, from the UE, a response to a previously issued authentication request, the response containing an identifier associated with a network in the plurality of 3GPP core networks; selecting an authentication server in accordance with the received identifier; and transmitting, towards the selected authentication server, an authentication request message determined in accordance with the received response.

In an embodiment of the third aspect of the present invention, the node is a WiFi Access Point. In a further embodiment, the authentication request is an Extensible Authentication Protocol (EAP) request, and optionally the received response is an EAP response. In a further embodiment, the identifier is a public land mobility network identifier. In another embodiment, the selected authentication server is an Authentication Authorization and Accounting server associated with the network associated with the received identifier. In another embodiment, the step of transmitting includes transmitting the authentication request message to a proxy Authentication Authorization and Accounting server for forwarding to an Authentication Authorization and Accounting server associated with the network associated with the received identifier. In a further embodiment, the authentication request message includes an access network identifier associated with the non-3GPP network. In another embodiment, the method further includes the step of receiving, from the selected authentication server, an authorization of the UE. In another embodiment, the method 16 further includes the step of forwarding the received identifier to a shared access router upon receipt of the authorization.

In a fourth aspect to the present invention, there is provided an access point in a non-3GPP network for providing access to one of a plurality of 3GPP core networks to a User Equipment. The access point comprises a network interface, a memory and a processor. The network interface allows for communication with the UE and an authentication server. The memory stores program instructions. The processor is operative connected to both the network interface and the memory, and upon executing the instructions stored in the memory, the processor can identify a message from the UE received over the network interface as a response, to a previously issued authentication request, that contains an identifier associated with a network in the plurality of 3GPP core networks; select an authentication server in accordance with the received identifier; and transmit, towards the authentication server, an authentication request message determined in accordance with the response received over the network interface from the UE.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 illustrates an EAP-SIM based access authentication procedure;

FIG. 2 illustrates a PLMN IND attribute for use in the method of FIG. 1;

FIG. 3 is a flow chart illustrating an exemplary embodiment of a method for execution at the UE;

FIG. 4 is a flow chart illustrating an exemplary embodiment of a method for execution in the non-3GPP network, such as at the WiFi AP; and

FIG. 5 is a block diagram illustrating an exemplary node of the present invention.

### DETAILED DESCRIPTION

The present invention is directed to a system and method for the UE to provide an indication to the WiFi network of a selected PLMN ID to prevent a mismatch in UE selected PLMN and AP selected PLMN.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

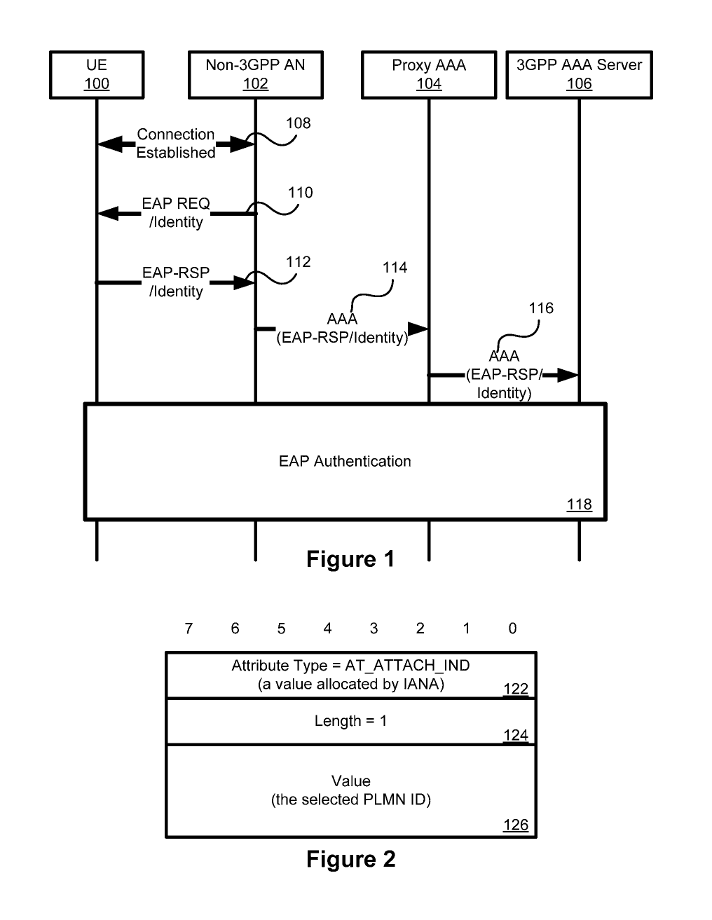

When accessing 3GPP core network via WiFi access network using S2a procedure, Extensible Authentication Protocol (EAP) SIM-based access authentication is typically required. FIG. 1 illustrates an EAP-SIM based access authentication procedure. Those skilled in the art will appreciate that although the following discussion makes reference to EAP-SIM, with minor variations, an EAP Authentication and Key Agreement (EAP-AKA) EAP-AKA' implementation can be provided. The UE 100 connects to an AP in the non-3GPP access network 102, and through network 102 access a 3GPP Authentication, Authorization and Accounting (AAA) server 106. This access may be done through a proxy AAA server 104 as discussed below. UE 100 connects an AP in network 102 as shown in connection 108. At this time, UE 100 finds it is in a shared network situation in which a plurality of PLMNs can be selected. UE 100 receives and EAP Request 100 to initiate the EAP-SIM based access authentication, the UE 100 can send the selected PLMN ID in the EAP-RSP message 112. FIG. 2 is an exemplary illustration of the EAP attribute 120 discussed in relation to FIG. 1.

The WiFi access point 102 uses the PLMN ID received in EAP-RSP 112 to select the shared core network including the AAA proxy 106 and access router (not shown). If the WiFi core network is also shared (i.e. the AAA proxy and access router are also shared) the WiFi access point can forward the received PLMN ID to the shared AAA proxy 104 as a part of the AAA EAP request 114. Those skilled in the art will appreciate that in the absence of proxy 104, the AAA EAP 114 can be forwarded directly to the AAA server 106.

Based on the received PLMN ID, the shared AAA proxy 104 can add the correct access network ID (ANID) to the AAA EAP request 116 which is sent to AAA server 106. The ANID is used for the charging record of the UE 100 at its home network. It should be noted that the ANID of the currently described process will be correct (not mismatched) because it is determined in accordance with the selection of the PLMN ID by the UE 100 instead of a network based guess that may result in a mismatch. One skilled in the art will appreciate that from this point forward, a conventional EAP AAA process can be undertaken as shown by box 118.

When the access authentication is accepted, the WiFi access point in network 102 can forward the selected PLMN ID to the shared access router (not shown). Then the shared access router can generate correct charging recorder of the UE at access network.

One skilled in the art will appreciate that the above described method may allow for both avoiding incorrect charging due to selection mismatch, and support for a business case permitting shared access networks.

The above discussion is based on treating the BBF compliant network as non-3GPP access. The same idea can be generalized to other non-3GPP accesses that might be used in the context of Fixed Mobile Convergence (FMC). This could be an access defined by the WiFi alliance.

FIG. 2 illustrates an exemplary embodiment of an attribute 120 that can be transmitted by UE 100 to the AP in network 102 to indicate the selected PLMNID. In the first octet 122, the attribute type is provided. In the second octet 124, the attribute length is provided, and in the final two octets 126 the selected PLMNID is provided as a value. One skilled in the art will appreciate that the AP in network 102 can easily parse an attribute provided in this fashion to make the decisions discussed above with respect to FIG. 1.

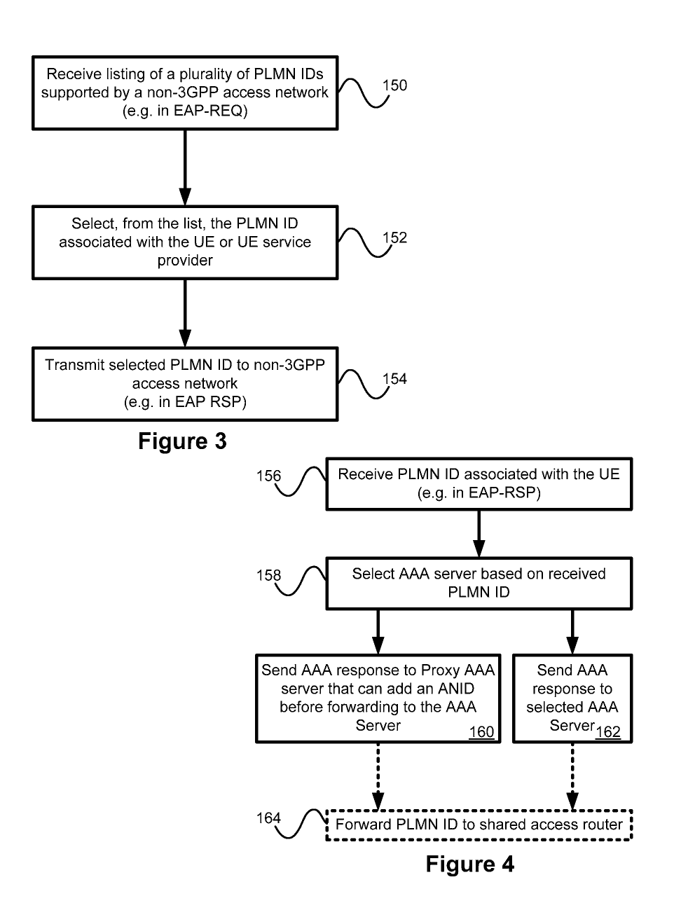

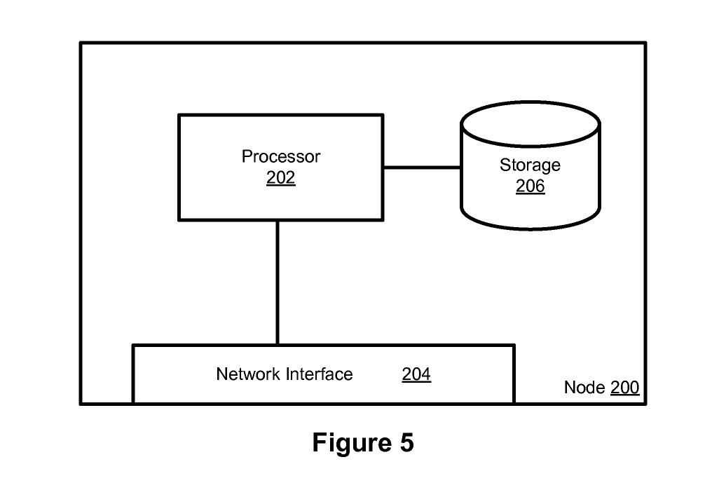

FIG. 3 is a flowchart illustrating a method that can be executed by UE 100. In step 150, UE 100 receives a listing that contains a plurality of PLMN IDs supported by the non-3GPP access network 102. One skilled in the art will appreciate that this advertisement of the PLMN IDs can be provided in the EAP request. In step 152, the UE 100 selects, from the received list, the PLMN ID that is associated with the UE, or with the UE's service provider. The selected PLMN ID is then transmitted, in step 154, to the non-3GPP access network node. This transmission is typically done in response to an authentication request, and the PLMN ID is included in the authentication response.

FIG. 4 is a flowchart illustrating a method that can be executed by a node such as the WiFi AP in network 102. In step 156, the node receives a PLMN ID associated with the UE. The PLMN ID is typically contained in an EAP response, which is commonly received in reply to an EAP REQ message. Based on the received PLMN ID, the node selects an AAA server in step 158. If it is a shared WiFi access network, the UE sends an AAA message based on the the EAP response to a proxy AAA server that can add the Access Network ID (ANID) to the AAA message prior to forwarding it to the selected AAA server as shown in 160. If it is not a shared WiFi AN, the UE sends an AAA message based on the the EAP RSP to the selected AAA Server in step 162. Optionally, the PLMN ID can be forwarded to the shared access router after authentication to facilitate smoother billing.

Both the UE 100 and the WiFi access point in network 102 can be implemented as a node 200 having a processor 202, network interfaces 204 and storage 206. The processor 200 can access instructions stored in the storage 206 (such as a memory) to implement the method and processes discussed above and shown in the figures. Communication with other nodes is achieved through the use of network interface 204.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

In the above discussion, and in the related Figures, a number of acronyms have been used. The following list provides definitions of some relevant acronyms.
3GPP—3^{rd} Generation Partnership Project
AN—Access Node
APN—Access Point Name
BBF—BroadBand Forum
BNG—Border Network Gateway
DHCP—Dynamic Host Configuration Protocol
FMC—Fixed-Mobile Convergence
GTP—GPRS Tunneling Protocol
IE—Information Element
IP—Internet Protocol
PDN—Packet Data Network
PGW—PDN GateWay
PMIP—Proxy Mobile IP
RG—Residential Gateway
UE—User Equipment
WLAN AP—Wireless LAN Access Point

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of facilitating access to a 3GPP core network associated with a User Equipment (UE) through a non-3GPP network, for execution by the UE, the method comprising:
receiving, from an access point in the non-3GPP network, an indication that a plurality of 3GPP core networks can be accessed through the non-3GPP network;
selecting, from the indicated plurality, the 3GPP core network associated with the UE; and
transmitting, to the access point, an identifier associated with the selected 3GPP core network.

2. The method of claim 1 wherein the step of receiving is preceded by a step of establishing a connection to the access point.

3. The method of claim 1 wherein the indication is received in an Extensible Authentication Protocol (EAP) request message.

4. The method of claim 3 wherein the identifier is transmitted in an EAP response message.

5. The method of claim 1 wherein the indication includes a list of Public Land Mobility Network identifiers (PLMN ID), each PLMN ID in the list associated with one of the plurality of 3GPP core networks.

6. The method of claim 1 wherein the identifier is a Public Land Mobility Network identifier.

7. A User Equipment (UE) for accessing a 3GPP core network associated with the UE through a non-3GPP core network comprising:
a network interface for communicating with an access point in the non-3GPP network,
a processor for executing instructions; and
a memory for storing instructions that when executed by the processor cause the processor to:
identify a message received from the access point through the network interface as an indication that a plurality of 3GPP core networks can be accessed through the non-3GPP network,
select the 3GPP core network associated with the UE from the plurality of 3GPP core networks, and
transmit to the access point through the network interface an identifier associated with the selected 3GPP core network.

8. The UE of claim 7 wherein the identified message is an Extensible Authentication Protocol (EAP) request message.

9. The UE of claim 8 wherein the stored instructions cause the processor to transmit the identifier as part of an EAP response message.

10. The UE of claim 7 wherein the indication includes a list of Public Land Mobility network Identifiers, each identifier in the list associated with one of the plurality of 3GPP core networks.

11. A method of facilitating access to one of a plurality of 3GPP core networks by a User Equipment (UE), the method for execution by a node in a non-3GPP network comprising:
receiving, from the UE, a response to a previously issued authentication request, the response containing an identifier associated with a network in the plurality of 3GPP core networks;
selecting an authentication server in accordance with the received identifier; and
transmitting, towards the selected authentication server, an authentication request message determined in accordance with the received response.

12. The method of claim 11 wherein the node is a WiFi Access Point.

13. The method of claim 11 wherein the authentication request is an Extensible Authentication Protocol (EAP) request.

14. The method of claim 13 wherein the received response is an EAP response.

15. The method of claim 11 wherein the identifier is a public land mobility network identifier.

16. The method of claim 11 wherein the selected authentication server is an Authentication Authorization and Accounting server associated with the network associated with the received identifier.

17. The method of claim 11 wherein the step of transmitting includes transmitting the authentication request message to a proxy Authentication Authorization and Accounting server for forwarding to an Authentication Authorization and Accounting server associated with the network associated with the received identifier.

18. The method of claim 11 wherein the authentication request message includes an access network identifier associated with the non-3GPP network.

19. The method of claim 11 further including the step of receiving, from the selected authentication server, an authorization of the UE.

20. The method of claim 19 further including the step of forwarding the received identifier to a shared access router upon receipt of the authorization.

21. An access point in a non-3GPP network for providing access to one of a plurality of 3GPP core networks to a User Equipment, the access point comprising:
a network interface for communicating with the UE and an authentication server;
a processor for executing instructions; and
a memory for storing program instructions that, when executed by the processor, cause the processor to:
identify a message from the UE received over the network interface as a response, to a previously issued authentication request, that contains an identifier associated with a network in the plurality of 3GPP core networks;
select an authentication server in accordance with the received identifier; and
transmit, towards the authentication server, an authentication request message determined in accordance with the response received over the network interface from the UE.
